(19) United States
(12) Patent Application Publication
(10) Pub. No.: US 2005/0200945 A1
(43) Pub. Date: Sep. 15, 2005

(54) Optical fiber communication systems with brillouin effect amplification

(75) Inventors: Paolo Fella, Valvori (IT); Orietta Quargnolo, Agrate Brianza (IT); Anotnio Bellosi, Firenze (IT)

Correspondence Address: KIRSCHSTEIN, OTTINGER, ISRAEL;& SCHIFFMILLER, P.C., 489 FIFTH AVENUE, NEW YORK, NY, 10017, US

(73) Assignee: MARCONI COMMUNICATIONS SPA, GENOVA (IT)

(21) Appl. No.: 10/504,498

(22) PCT Filed: Feb. 12, 2003
(86) PCT No.: PCT/IB03/00981

§ 371 Date: May 17, 2005

(30) Foreign Application Priority Data
Feb. 15, 2002 (IT) M12002A000301

(51) Int. Cl. H01S 3/00

(52) U.S. Cl. 359/334

(57) ABSTRACT

An optical fiber transmission system comprising a transmitter and a receiver at the two ends of an optical fiber. The transmitter comprises a signal laser for generation of a transmission signal and the receiver comprises a pump laser for production of a pump signal, which is incorporated in the fiber in a direction opposite to that of the transmission signal to obtain amplification using the Brillouin effect of the transmission signal. The central frequency, Fsign, of the transmission signal of the signal laser and the central frequency, Fpump, of the pump signal of the pump laser are such that (Fpump±20 MHz)−(Fsign±20 MHz)=10 GHZ±0.1 GHz, and the two lasers are controlled locally such that the maximum variation, Δfsign, of the central frequency of the transmission signal, the maximum variation, Δfpump, of the central frequency of the pump signal, and the bandwidth, Bfsign, of the transmission signal have the following relationship: Bfsign+Δfsign+Δfpump=100 MHz.

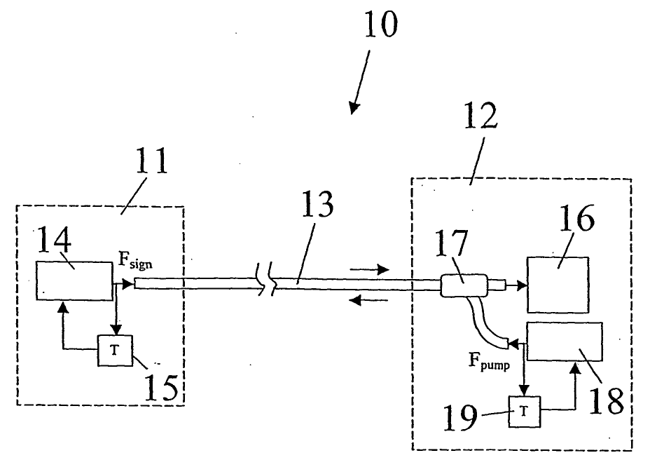

The present invention relates to an optical fiber communication system, using so-called Brillouin scattering to obtain amplification of narrow bandwidth signals passing through the fiber.

As is known from theory, the Brillouin effect is caused by the non-linearity of optical fibers and generates a wave which propagates in a direction opposite to that of the signal in the fiber, the frequency of the wave being shifted downward by a few tenths of a GHz in comparison to the frequency of the signal, and which wave is amplified at the expense of the signal. This effect therefore induces a loss of energy in the signal each time the incident power exceeds a threshold value, and thus constitutes an additional attenuation mechanism. In this sense, the Brillouin effect is a deleterious effect in the transmission of optical signals and should accordingly be carefully avoided.

In the prior art of optical fiber communication systems optical devices have been proposed which advantageously make use of the Brillouin effect. In particular, local optical signal discriminators and amplifiers have been proposed. These devices are based on the non-linear Brillouin effect, which causes part of the power of a signal termed “pump” at an appropriate wavelength lₚ to be transferred to the useful signal with wavelength l₀. The useful signal and pump signal should be counterpropagating and should have a small difference in wavelength.

In accordance with the teaching of the prior art, amplifiers can be obtained which can be useful as frequency selective members in frequency division multiplexing systems to realize active optical filters. For example, EP 0261876 describes a receiver capable of selecting a single preset signal from among a certain number of optical signals reaching it from an optical communication system capable of transmitting a plurality of information signals. EP 0261876 proposes a fixed relationship between the frequency of the optical signal transporting the information, Fsign, and the frequency of the pump signal, Fpump. In particular, the relationship Fsign=Fpump[1-2n(v/c)] where n=refractive index of the fiber, v=acoustic velocity in the fiber, and c=velocity of light in a vacuum, is recommended.

U.S. Pat. No. 5,515,192 describes an optical signal generator, with, among other things, a narrow bandwidth amplifier using the Brillouin effect. Again, in this patent a relationship between preset fixed frequencies for the pump signal and the signal to be amplified is given.

In accordance with the prior art, the laser producing the signal to be amplified and the laser producing the pump signal must necessarily have a very precise frequency relationship with each other. This greatly limits the practical applications of such a system, since the availability of lasers with the required stability is difficult.

The general purpose of the present invention is to remedy the above mentioned shortcomings, by making available an optical fiber communication system utilizing the Brillouin effect which would permit handling signals with a relatively narrow bandwidth, for example with characteristics similar to those of optical supervisory channel (OSC) signals of wavelength division multiplexing (WDM) or dense wavelength division multiplexing (DWDM) systems. Such a new communication system could thus either replace communication systems having more costly, cumbersome and high-consumption erbium-doped fiber amplifiers (EDFAs) in low bit-rate applications, synchronous digital hierarchy (SDH) or non SDH, or be advantageously used in so-called festoons (i.e. very long single section optical links) to amplify OSC out-of-band signals for DWDM applications. In the prior art, OSC signals cannot be used on festoons because these signals cannot be adequately amplified by EDFA boosters as they are outside the wavelengths which can be handled by EDFAs. Lack of OSC signals means lack of network management between the two end points of the festoons and possibly between the subnetworks coupled therewith.

In view of this purpose it was sought to provide in accordance with the present invention, an optical fiber transmission system comprising a transmitter and a receiver at the two ends of an optical fiber, the transmitter comprising a signal laser for generation of a transmission signal and the receiver comprising a pump laser for production of a pump signal which is incorporated in the fiber in a direction opposite to that of the transmission signal to obtain amplification using the Brillouin effect of the transmission signal, wherein the central frequency, Fsign, of the transmission signal of the signal laser and the central frequency, Fpump, of the pump signal of the pump laser are such that (Fpump±20 MHz)−(Fsign±20 MHz)=10 GHz±0.1 GHz, and the two lasers are controlled locally such that the maximum variation, Δfsign, of the central frequency of the transmission signal, the maximum variation, Δfpump, of the central frequency of the pump signal, and the bandwidth, Bfsign, of the transmission signal have the following relationship Bfsign+Δfsign+Δfpump=100 MHz.

The transmission signal may have a bandwidth of the order of 20 MHz. The transmission signal may have a bandwidth less than 10 MHz. The transmission signal may be an optical supervisory channel (OSC) signal of a DWDM transmission system. The frequency of the transmission signal of the signal laser may be held around ±20 MHz of the central frequency Fsign. The frequency of the pump signal of the pump laser may be held around ±20 MHz of the central frequency Fpump. The signal laser and the pump laser may be controlled locally using feedback devices.

To clarify the explanation of the innovative principles of the present invention and its advantages compared with the prior art, an embodiment of the invention is described below by way of example only, with reference to the accompanying drawing.

The drawing shows an optical fiber communication system 10 in which optical signals are transmitted by a transmitter 11 to a receiver 12 along an optical fiber 13. The transmitter comprises a signal laser 14, which generates transmission signals and is frequency stabilized by means of a feedback device 15 (advantageously of the heat controlled type) to hold the central frequency, Fsign, of the transmission signals in a predetermined range. The receiver 12 comprises a detector 16, which receives signals from the fiber 13, for detection and treatment in accordance with the known art. At the input of the receiver 12, is a known optical coupler 17 which permits pump signals produced by a pump laser 18 to be input into the fiber 13 in a direction towards the transmitter 11. The pump laser 18 is also frequency stabilized by means of a feedback device 19 (again advantageously of the heat-controlled type) to hold the central frequency, Fpump, of the pump signals in a preset range.

In the fiber 13 there is thus at least one transmission signal directed from the transmitter to the receiver and one pump signal directed in the opposite direction.

The fiber between a transmitter and a receiver in a system in accordance with the present invention, can have a length from a few kilometers to several hundred kilometers.

Other communication signals in addition to the transmission signal produced by the signal laser 14 can transit along the fiber. These signals can be completely independent of the transmission signal, or the transmission signal can be a service signal associated with the other communication signals in the fiber, such as a OSC signal in a WDM (or DWDM) transmission system. In any case, the other communication signals have frequencies sufficiently different from the transmission signal, so as to not interfere with the transmission signal, and if desired or required will be amplified by known means, for example EDFAs, if possible.

In accordance with the present invention the bandwidth of the transmission signals is preferably at most of the order of 20 MHz, and the transmission signals are accordingly narrow bandwidth signals. For example, a typical OSC signal has a bandwidth of approximately 2 MHz.

The frequency variations admitted by the feedback signal laser system 14, 15 and the feedback pump laser system 18, 19, must be such that the bandwidth, Bfsign, of the transmission signals produced by the signal laser 14, plus the maximum variation |Δfsign| of the central frequency of the transmission signals (or even the spectral bandwidth) of the signal laser 14, plus the maximum variation |Δfpump| of the central frequency of the pump signals (or even the spectral bandwidth) of the pump laser 18 will be within 100 MHz, i.e.: Bfsign+|Δfsign|+|Δfpump|=100 MHz.

It was surprisingly found that with a system realized as set forth above, the signal reaching the receiver 12 is amplified in a very satisfactory manner (more than 30 dB of optical gain with a pump laser power between 1 and 10 mW), so that it is possible, for example, to realize very long fiber sections (up to several hundred kilometers), which are amplified economically and are commercially feasibly.

For example, in the case of a OSC signal of a DWDM transmission system with a 2 MHz bandwidth whose frequency is greater than 1 THz, adopting appropriate safety margins, the pump and signal laser central frequencies must merely be held in a bandwidth such that (Fpump+/−20 MHz)−(Fsign+/−20 MHz)=(10 GHz+/−0.1 GHz). The frequency of the pump signals is approximately 10 GHz higher than the frequency of the transmission signals.

This allows amplification of the service signals in festoon type fiber sections. It is also possible to realize low traffic fiber sections, directed for example for individual users or groups of users, which permits optical fiber telecommunication services to reach even isolated localities which would not be economically profitable to serve if the use of conventional amplification systems were necessary.

It should be noted that the frequency or spectral stability and the mutual relationship required of the pump and signal lasers is sufficiently wide to be maintainable by local feedback devices with no need for any system which keeps the signals from the two lasers coupled.

A communication system in accordance with the present invention is relatively economical, allows replacement of the more costly and cumbersome EDFAs, and amplification of low and very low bit-rate signals and OSC DWDM signals on connections with very long fiber sections (festoons).

Naturally the above description of an embodiment applying the innovative principles of the present invention is given by way of a non-limiting example of said principles within the scope of the exclusive right claimed here.

1-6. (canceled)

7. An optical fiber transmission system, comprising: an optical fiber having two ends; a transmitter at one of the ends of the fiber, the transmitter including a signal laser for generating a transmission signal; a receiver at the other of the ends of the fiber, the receiver including a pump laser for producing a pump signal which is incorporated in the fiber in a direction opposite to a direction of the transmission signal to obtain amplification using the Brillouin effect of the transmission signal; the transmission signal of the signal laser having a central frequency (Fsign) and the pump signal of the pump laser having a central frequency (Fpump) such that (Fpump±20 MHz)−(Fsign±20 MHz)=10 GHz±0.1 GHz; and means for locally controlling the lasers such that a maximum variation (Δfsign) of Fsign, a maximum variation (Δfpump) of Fpump, and a bandwidth (Bfsign) of the transmission signal have the following relationship: Bfsign+Δfsign+Δfpump=100 MHz.

8. The system according to claim 7, in that the Bfsign is of the order of 20 MHz.

9. The system according to claim 8, in that the Bfsign is less than 10 MHz.

10. The system according to claim 7, in that the transmission signal is an optical supervisory channel (OSC) signal of a dense wavelength division multiplexing (DWDM) transmission system.

11. The system according to claim 7, in that the transmission signal of the signal laser has a frequency held around ±20 MHz of the Fsign, and the pump signal of the pump laser has a frequency held around ±20 MHz of the Fpump.

12. The system according to claim 7, in that the means for locally controlling the lasers are feedback devices.
